(19) United States
(12) Patent Application Publication
(10) Pub. No.: US 2014/0106915 A1
(43) Pub. Date: Apr. 17, 2014

(54) QUICK-ACTION CHAIN TENSIONING DEVICE FOR A CHAINSAW, AND SUCH MECHANISM AND METHOD

(71) Applicants: Michael Kistler, Ulm (DE); Markus Maag, New-Ulm (DE); Christoph Schiedt, Burgrieden (DE); Pär Martinsson, Jonkoping (SE); Joakim Persson, Skillingaryd (SE); Michael Trevor, Durham (GB); Nick Downes, Maple Ridge (CA)

(72) Inventors: Michael Kistler, Ulm (DE); Markus Maag, New-Ulm (DE); Christoph Schiedt, Burgrieden (DE); Pär Martinsson, Jonkoping (SE); Joakim Persson, Skillingaryd (SE); Michael Trevor, Durham (GB); Nick Downes, Maple Ridge (CA)

(73) Assignee: Husqvarna AB, Huskvarna (SE)

(21) Appl. No.: 14/124,080

(22) PCT Filed: Jun. 7, 2012
(86) PCT No.: PCT/SE2012/050613

§ 371 Date: Dec. 5, 2013

(30) Foreign Application Priority Data
Jun. 7, 2011 (SE) PCT/SE2011/050694

(51) Int. Cl. F16H 7/08

(52) U.S. Cl. CPC F16H 7/08
USPC 474/111

(57) ABSTRACT

To facilitate the demounting of a chain (3) from a chainsaw, the saw has a lever arm preferably in the form of hinged cover (11) arranged to displace the sprocket (15) towards the guide bar (2) the other upon opening of the cover (11). Upon closing the cover (11), the sprocket (15) is displaced in the opposite direction to pre-tension the chain (3). The sprocket (15, 115) may be driven over a gear transmission (27, 127), which when the chain (3, 103) is running at ordinary cutting speed uses resulting forces to automatically tension the chain (3, 103) by displacing the sprocket (15, 115) away from the guide bar (2, 102). A ratchet mechanism (34) may be provided to maintain the chain tension upon reduction of the chain speed by preventing the sprocket (15) from moving toward the guide bar (2).

Alternatively, a mechanism for automatically tensioning the chain (3, 238) of a chainsaw includes a driving inner sprocket (76, 201), and an outer ring member (77, 204) surrounding the inner sprocket (76, 201). A spring (64, 87, 228) may be provided for assisting the ratchet mechanism or as a substitute therefore.

### TECHNICAL FIELD

The present invention relates to a quick-action device for facilitating attachment/detachment of the a saw chain of a chainsaw, the chain saw further including a guide bar and a rotatable chain guiding member for guiding the chain, and a drive sprocket for driving the chain

Further, it relates to a mechanism for automatically tensioning the chain of a chainsaw having a saw chain, a guide bar and a rotatable chain guiding member for guiding the chain, a driven output shaft, and a gear transmission for operatively connecting the output shaft to the chain guiding member

It also relates to a method of automatically tensioning the chain of a chainsaw having saw chain, a guide bar and a rotatable chain guiding member for guiding the chain, a driven output shaft, and a gear transmission for operatively connecting the output shaft to the chain guiding member.

### BACKGROUND ART

WO 2010/105809 A1 discloses a quick-tightening device and a suitable chain unit and a guide bar, by means of which the saw chain and the guide bar can be easily attached to the main body of the chainsaw, and by which the saw chain can be tensioned without any problems. In the quick-tightening device, a wedge is assembled on the guide bar of the chainsaw, while a movable clamping lever array containing a hinged cover and a counter wedge is secured to the chassis in the region of the driveshaft. The motion sequence of the elements of the clamping lever array in the transition from the open position to the closed position is specially designed, so that the counter wedge acts on the wedge assembled on the guide bar and locks the guide bar to the chassis by means of contact pressure. At the same time, the guide bar is pushed by the pushing pressure in longitudinal direction away from the drive pinion, so that the saw chain is tensioned. In this way, the mounting of chain and guide bar at the assembling of the chainsaw is simple, and the tensioning of the chain without any problems is facilitated. However, even though the clamping lever array works satisfactorily, it is a quite complicated design.

In WO 2010/149338 A1 there is disclosed a chainsaw having a guide bar, a drive pinion associated with a drive, and a cutting chain running over the guide bar and the drive pinion, that can be tensioned and detensioned by a relative displacement of the guide bar or a part of the guide bar, particularly the bar tip disposed at the end of a slider, and the drive pinion, wherein according to the invention a sensor element, such as a displaceable or pivotal roller or slide element, for capturing a change in the chain tension is disposed between the drive pinion and the guide bar, preferably in the region of the chain departing from the drive pinion, and a continuously operating adjusting unit is provided for generating the relative displacement independently of the load on the chain on the basis of the change in chain tension. A signal from the sensor element activates a motor that displaces the guide bar, for example, so as to automatically adjust the tension of the chain. The automatic adjustment of the tension of the chain by means of a sensor element and a motor makes also this design complicated.

U.S. Pat. No. 6,694,623 discloses a cam lever arrangement which permits the loosening and tightening of the chain on the guide bar with a lever motion. The lever arrangement is connected to the motor housing cover door. Opening the door automatically loosens the chain by moving the guide bar towards the drive sprocket. Closing the door automatically tightens the chain by moving the guide bar away from the drive sprocket. Precision adjustments to tension are made by hand manipulation of a turnbuckle which is free from pressure when the lever is in the release position.

WO 95/33604 discloses a drive sprocket assembly for chain saws, where a saw chain runs around a loose drive ring that rolls upon cylindrical surfaces of a drive sprocket. Drive links of the saw chain project through holes of the drive ring and enter recesses of the drive sprocket to be driven thereby. The recesses of the drive sprocket have an axial dimension substantially larger than the thickness of the drive links, to enable the drive ring and chain to have substantial axial play relative to the drive sprocket. Such a design will tension the saw chain with a force that is proportional to the actual cutting force, but it will result in a slacked saw chain when the chain isn't running. To reduce the risk of jumping of the chain, the sides of the recesses in the drive sprocket may be formed by slightly tapered end surfaces of elastic rings to keep the drive links from climbing the elastic rings when they enter the recesses.

### SUMMARY OF THE INVENTION

One object of the present invention is to provide a quick-action device for demounting a saw chain from a chainsaw, where the operator easily can remove the chain from the chainsaw.

In a first preferred embodiment of the present invention, this object is achieved in a quick-action device of the kind referred to in the first paragraph above, in that

a) the chain guiding member is mounted to be displaceable toward and away from the guide bar; and
b) a lever arm is operatively connected to displace the chain guiding member in the directions toward respectively away from the guide bar upon actuation thereof, thereby facilitating attachment/detachment of the chain from the saw when the chain guiding member is displaced towards the guide bar.

Thus, this simple design makes it possible for the operator to remove the chain simply by actuating the lever arm in one direction to loosening the chain, and then tightening the chain by actuating the lever arm in opposite direction. By displacing the chain guiding member instead of the guide bar, the guide bar can be firmly secured to the body of the chain saw, thereby increasing stability of the guide bar.

Preferably the lever arm is a hinged cover covering the chain guiding member and adjacent portion of the guide bar and the chain, so that the chain guiding member is displaced in a direction towards the guide bar on opening of the hinged cover, and in a direction away from the guide bar on closing the hinged cover, thereby facilitating attachment/detachment of the chain from the saw when the hinged cover is open.

Preferably, the quick-action chain tensioning device further includes a ratchet mechanism, which after closing of the cover maintains the chain guiding member in its intended position, and on opening of the cover releases the chain guiding member, thereby releasing the tension in the chain.

It is also preferred that a spring member is operatively connected between the guide bar and the chain guiding member for biasing the chain guiding member in a direction away from the guide bar so as to maintain the saw chain tensioned unless the lever arm is actuated to move the sprocket toward the guide bar.

Another object of the present invention is to provide a mechanism for automatically tensioning the chain of a chainsaw.

In a second preferred embodiment of the present invention, this object is achieved in a chain tensioning mechanism of the kind referred to in the second paragraph above in that:

a) the chain guiding member is mounted to be displaceable in a direction away from the guide bar, and thereby apply tension to the chain, by forces that result in the gear transmission due to resistance from rotating the chain guiding member, when the chain saw is driven; and the mechanism including at least one of:
b) a chain tension maintaining mechanism that upon reduction of the speed of a running chain maintains the chain tension by preventing the chain guiding member from moving toward the guide bar,
c) a pre-tensioning mechanism operatively connected to the chain guiding member biasing the chain guiding member in a direction away from the guide bar to ensure that at least a minimum tension of the chain is provided at start of the chain saw.

Thereby, a chain running at normal cutting speed will always have the desired tension. The chain tension maintaining mechanism, preferably a ratchet mechanism, ensures that the tensioning of the chain does not have to start from zero or a very low tension at each start of the chainsaw. Further, the chain tension maintaining mechanism is especially useful when the running chain is stopped suddenly, as it prevents the chain from leaving the guide bar, e.g. at a kickback situation, when the front hand guard brakes the chain. The pre-tensioning mechanism ensures that sufficient tension of the chain is ensured to activate the automatic chain tensioning.

The ratchet mechanism may include a ratchet wheel, and a gear train converts the displacement of the chain guiding member to a rotation of the ratchet wheel. And further a pivotal pawl, a pivotal slide that is pivotally carried by the arm connecting the hinged cover to the push/pull rod member, and the pivotal slide controlling activation/deactivation of the pivotal pawl.

Preferably the gear transmission includes a first gear fixed on the output shaft, and a second gear mounted coaxially with the chain guiding member and operatively connected thereto.

Preferably the mechanism includes a second shaft, on which the sprocket and the second gear are coaxially mounted thereby operatively connecting them on the second shaft, and a support device that is pivotal on a rotation axis of the output shaft and carries the second shaft for pivotal movement of the chain guiding member substantially in a longitudinal direction of the guide bar.

Preferably, the support device includes a pivotal housing (22) enclosing the gears (28, 31), and the first and second gears (28, 31) are in direct meshing engagement with each other.

Alternatively, the gear transmission further includes an intermediate third gear mounted on a third shaft carried by the support device and meshing with the first gear and the second gear to transmit rotation of the first gear to the second gear and thus to drive the chain guiding member. Preferably, the support device includes a first link maintaining a predetermined distance between the output shaft and the third shaft, a second link maintaining a predetermined distance between the third shaft and the second shaft, and a pivotal third link having a fixed end and an opposite end that carries the second shaft, said first link and second link forming a variable angle elbow to permit the chain guiding member to move toward or away from the output shaft. Preferably, the output shaft with the first gear is arranged between the guide bar and the chain guiding member and substantially on a level with them.

Preferably the chain guiding member is the drive sprocket engaging and driving the chain.

The chain guiding member may be a ring member loosely surrounding the first gear, the ring member having a radially outer side shaped to guide the saw chain and a radially inner side structured for a meshing engagement with the first gear.

Preferably, the first gear has support surfaces for supporting varying supported surfaces on the radially inner side of the ring member, the ring member has radial through openings for inwardly extending portions of drive links included in the saw chain, and the first gear being a driving sprocket that has teeth with portions engaging the drive links.

Preferably, each tooth of the first gear has two lateral ends with recessed portions that form shoulders, which constitute said support surfaces, the remaining intermediary top portion of each tooth being the portion that engages the drive links.

Preferably, the ring member comprises two axial halves interconnected by rung-like members like in a ladder, the space formed between the two halves constituting the radial through openings for the inwardly extending portions of drive links.

The pre-tension mechanism may include a holder adapted to be attached to a rear end of the guide bar, two parallel rods mounted movably on the holder and extending side by side in the direction of the guide bar, each rod having a portion extending rearward from the holder and in addition an end located proximate the ring member, the rod ends being interconnected by a cross piece, the cross piece having a projecting member adapted to contact the radially outer side of the ring member, and helical compression springs being mounted around said portions of the rods to press the projecting member against the radially outer side of the ring member and thereby ensuring a minimum tension in the saw chain and driving engagement between the first gear and the saw chain.

Preferably, the projecting member includes a rotary wheel adapted to contact the radially outer side of the ring member.

Preferably, the rods have distal ends provided with a threaded portion and a nut screwed onto the threaded portion for pre-tensioning the compression springs.

Preferably, the pre-tensioning mechanism presses the ring member against the first gear at a position below the center of the first gear.

Alternatively, the first gear, and the outer ring member have meshing teeth arranged to form a smaller pitch circle and a larger pitch circle, and a device is provided for allowing a center of the outer sprocket ring member to move along a restricted angular path formed by a periphery of a semicircle around a center of the driving inner sprocket, said semicircle having a diameter that is equal to a difference in diameter between the two pitch circles.

Upon starting the engine, the forces between the first gear and the outer ring member will cause an angular displacement of the outer ring member around the first gear and thereby tension the saw chain automatically.

The device may include:
a) a chainsaw platform that is integral with or adapted to be fixed to a chainsaw housing;
b) a slide plate that is carried by and movable in relation to the chainsaw platform;
c) a rolling-element bearing having an outer race ring and an inner race ring and having one of the race rings fixed to the slide plate, said outer sprocket ring member being fixed to the other race ring;
d) a rotary shaft carried by the chainsaw platform and extending through a semicircular opening in the slide plate, said shaft being operatively connected to the slide plate to move it upon rotation of the shaft;
e) a plurality of eccentric bearings connecting the slide plate to the chainsaw platform to restrict the movement of the slide plate to movements along said semicircular path; and
f) a spring member having one end attached to the chainsaw platform and the other end to the shaft in such a manner that the slide plate with the outer ring member maintains the saw chain pre-tensioned.

The ring member may have external teeth for engaging the inwardly extending portions of drive links of the saw chain. If desired, the external teeth may be sandwiched between two rings included in the ring member. Then, the radial outer surface of the two rings form a support surface for the chain, and the spaces defined by the two rings and the external teeth of the ring member form recesses in the ring member for receiving the inwardly extending portions of the drive links.

Still another object of the present invention is to provide a method of tensioning the chain of a chainsaw, where the chain is tensioned automatically.

In a third preferred embodiment of the present invention, this object is achieved in a chain tensioning method of the kind referred to in the third paragraph above by running the chain, whereby forces result in the gear transmission due to resistance from rotating the chain guiding member, and utilizing said resulting forces to displace the chain guiding member away from the guide bar so as to tension the chain.

Thereby, a chain running tensions the chain, and hence a chain running at normal cutting speed will thus get the desired tension.

The method preferably includes providing a mechanism, suitably a ratchet mechanism, which maintains the chain tension upon reduction of the chain speed by preventing the chain guiding member from moving toward the guide bar. Thereby, the tensioning of the chain does not have to start from zero or a very low tension at each start of the chainsaw.

The method preferably includes providing a pre-tensioning mechanism operatively connected to the chain guiding member biasing the chain guiding member a direction away from the guide bar to ensure that at least a minimum tension of the chain provided at start of the chain saw.

Preferably, the gear transmission includes a first gear fixed on the output shaft, and a second gear mounted coaxially with the chain guiding member and operatively connected thereto.

In one variant the mechanism further includes a second shaft, on which the chain guiding member and the second gear are coaxially mounted thereby operatively connecting them on the second shaft, and a support device that is pivotal on a rotation axis of the output shaft and carries the second shaft for pivotal movement of the chain guiding member substantially in a longitudinal direction of the guide bar.

In a variant of the second and third preferred embodiments, the gear transmission further includes an intermediate third gear mounted on a third shaft carried by the support device and meshing with the first gear and the second gear to transmit rotation of the first gear to the second gear and thus to drive the chain guiding member.

Then, it is suitable that the support device includes a first link maintaining a predetermined distance between the output shaft and the third shaft, a second link maintaining a predetermined distance between the third shaft and the second shaft, and a third pivotal link having a fixed end and an opposite end that carries the second shaft, said first link and second link forming a variable angle elbow to permit the chain guiding member to move toward or away from the output shaft.

It is also suitable, that the output shaft with the first gear is located between the guide bar and the chain guiding member and substantially on a level with them.

In a another variant of the second and third preferred embodiments, the support device includes a pivotal housing enclosing the gears, and the first and second gears are in direct meshing engagement with each other.

### BRIEF DESCRIPTION OF THE DRAWINGS

In the following, the invention will be described in more detail with reference to preferred embodiments and the appended drawings.

FIG. 1 is a perspective view of a chainsaw having a quick-action device for demounting the chain from the saw as well as automatically tensioning the chain.

FIG. 2 is a perspective view of a preferred embodiment of an assembly incorporating the quick action device of FIG. 1 having a hinged cover.

FIG. 3 is a perspective view of the assembly of FIG. 1 having the hinged cover removed to expose the attachment of the guide bar, the sprocket with the chain, and there below a stationary cover.

FIG. 4 is a perspective view of a hinged cover included in the device of FIG. 2.

FIG. 5 is a cross sectional view showing the hinged cover and adjacent components of the quick action device.

FIG. 6 is a perspective view similar to FIG. 3 but having also the stationary inner cover removed to show a pivotal housing surrounding a two-gear transmission for transmitting rotational force from an outgoing shaft from a motor to a sprocket for driving the chain.

FIG. 7 is a plan view similar to FIG. 6 but having part of the pivotal housing removed to show the two-gear transmission in a position for demounting the chain from the guide bar or mounting it thereon.

FIG. 8 is a plan view similar to FIG. 7 but having the pivotal housing pivoted to a position where the two-gear transmission has tensioned the chain on the guide bar.

FIG. 9 is a section of a plan view showing an arrangement for making a pivotal pawl carrying arm move into and out of engagement with a toothed rack of a ratchet mechanism.

FIG. 10 is a plan view showing the pawl carrying and toothed rack components in detail.

FIG. 11 is a cross sectional view showing the two-gear transmission and a surrounding pivotal housing mounted on a base plate.

FIG. 12 is a plan view of a second preferred embodiment of the gear transmission, which here has three gears.

FIG. 13 is a plan view similar to FIG. 12, but having the chain and the middle gear removed to show the pivotal links used to control the movements of the middle gear and the sprocket.

FIG. 14 is a perspective view of an assembly incorporating another preferred embodiment of a quick action device for demounting a saw chain from a chainsaw as well as automatically tensioning the chain, having a hinged cover in an open position but removed to expose the attachment of the guide bar, the sprocket, and the two-gear transmission of FIGS. 6-8 and 11 pivoted to a forward position to enable a shift of saw chain.

FIG. 15 is a perspective view showing the assembly of FIG. 14 when the removed cover is closed so that the two-gear transmission is pivoted to a rear position assisted by a spring and the saw chain is tensioned for sawing.

FIG. 16 is a perspective view showing the pawl and ratchet mechanism of the assembly of FIG. 14.

FIG. 17 is a side view of an alternative preferred mechanism for automatically tensioning the chain and including a spring-operated mechanism for pressing a ring member against an inner sprocket.

FIG. 18 is a perspective view of the mechanism of FIG. 17.

FIG. 19 is a side view of the mechanism of FIGS. 17 and 18 showing a portion of a saw chain supported by the ring member.

FIG. 20 is a top view of the mechanism of FIG. 19.

FIG. 21 is a cross-sectional view taken along line XXI-XXI in FIG. 20.

FIG. 22 is a perspective view of still another alternative preferred mechanism for automatically tensioning the chain but with a clutch drum removed for showing the inner first gear and the surrounding outer ring member when the chain is running.

FIG. 23 is a side view of the mechanism of FIG. 22.

FIG. 24 is a side view of the mechanism of FIG. 22 when the chain is assembled for the first time and is not yet tensioned by the mechanism.

FIG. 25 is an exploded perspective view of the automatically tensioning mechanism of FIG. 22 but showing also the clutch drum.

FIG. 26 is a side view of the mechanism of FIG. 25.

FIG. 27 is a cross-sectional view taken along line XXVII-XXVII in FIG. 26.

### MODE(S) FOR CARRYING OUT THE INVENTION

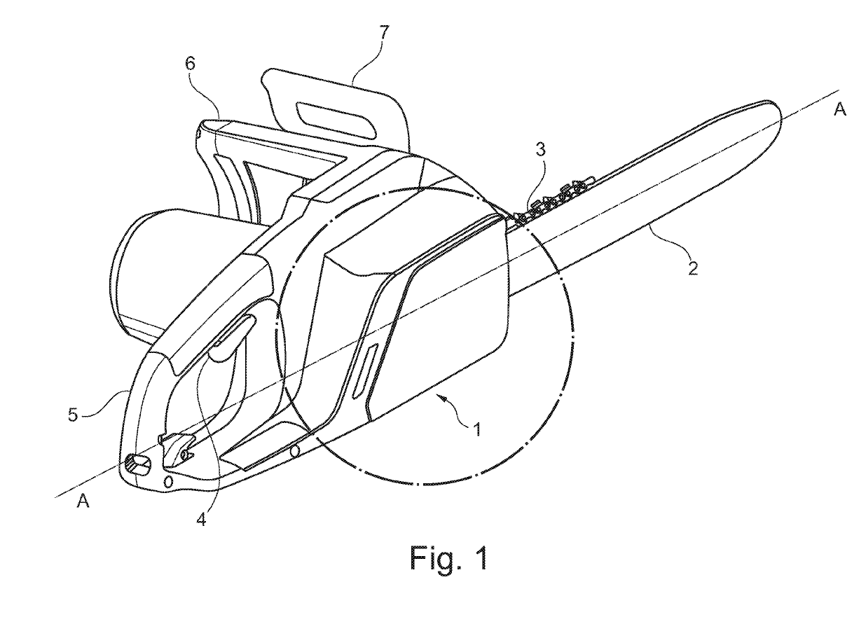

FIG. 1 illustrates a chainsaw, according to an exemplary embodiment of the present invention. The chainsaw includes a housing 1 and a cutting unit. The housing encloses a prime mover (not shown). In various embodiments of the present invention, the prime mover may include a motor or an internal combustion engine. In an embodiment of the present invention, the motor may be an electrically powered motor, such as, but not limited to, AC motor, DC motor, and the like. In an embodiment of the present invention, the motor may be selectively supplied with electrical energy by a rechargeable power source, such as an accumulator or battery (not shown in FIG. 1) also enclosed within the housing. Further, the cutting unit includes a guide bar 2 which is attached to the housing 1 and extends along a longitudinal axis A. In case the prime mover is a combustion engine, the guide bar is preferably attached to a crankcase. The cutting unit also includes a chain 3, which is supported over a peripheral guiding slot provided in the guide bar 2. In various other configurations, the cutting unit may also include a nose sprocket at a distal end of the guide bar 2 with respect to the housing 1.

An activation switch 4. e.g. a throttle trigger, may be provided to activate or deactivate the movement of the chain 3 along the peripheral guiding slot of the guide bar 2. The activation switch 4 may act as trigger switch to energize the prime mover and provide a rotational motion to a drive or output shaft (not shown in FIG. 1). Further, the housing 1 may include a rear handle 5 and a front handle 6. The rear handle 5 may include a grip portion to aid in manual grasping of the chainsaw. Further, a front handguard 7 and combined chain brake lever may be present to safeguard a user during a cutting operation.

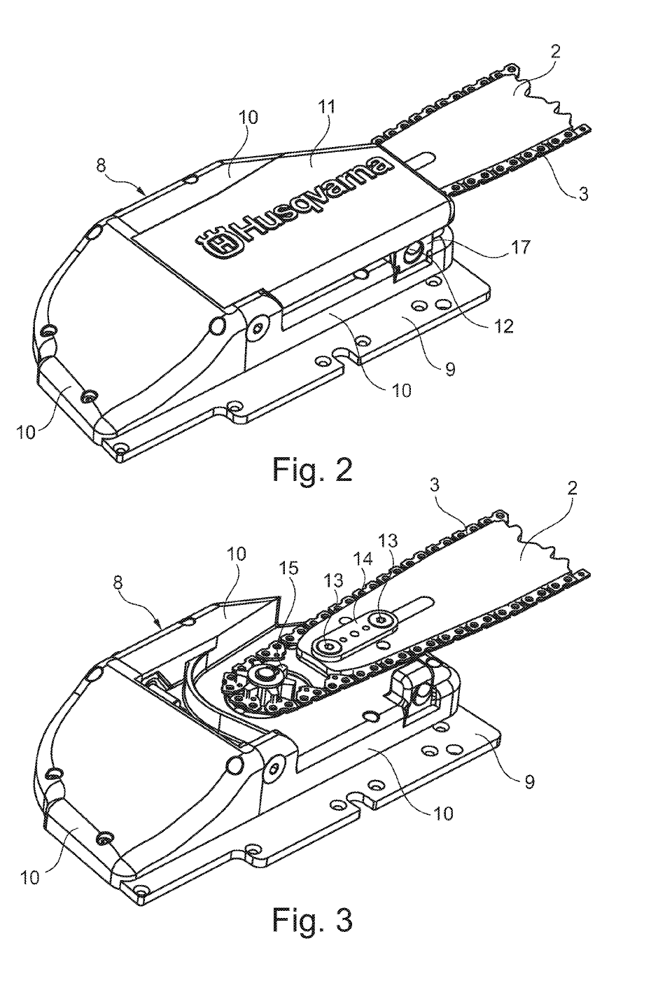

FIG. 2 shows an assembly 8 incorporating a quick action device in accordance with a first preferred embodiment of the present invention for demounting the chain from the saw as well as automatically tensioning the chain in the saw of FIG. 1. The assembly includes a base plate 9, a gear transmission (not shown in FIG. 2) carried by the base plate 9 for transmitting the rotation of the output shaft (not shown in FIG. 2) to the sprocket (not shown in FIG. 2), a stationary cover 10 attached to the base plate 9 and enclosing the gear mechanism, and a hinged cover 11 pivotally attached to the stationary cover 10 and shielding the sprocket and adjacent portions of the chain 3. In the embodiment of FIG. 2, the hinged cover 11 is hinged at its rear end, distal from the guide bar 2. To avoid an inadvertent opening of the hinged cover 11, it is locked at its opposite end to the stationary cover 10 by a releasable locking mechanism, in the embodiment shown in the figures, two spring-operated buttons 12, which have to be pressed down simultaneously to release the hinged cover 11 from the locked condition. Of course, the releasable locking mechanism may be configured differently.

FIG. 3 shows the assembly when the hinged cover 11 is made invisible. By means of two screws 13 and an intermediate assembling plate 14, the guide bar 2 is secured to a guide bar adapter (14′, shown in FIG. 11), which is secured to the base plate 9. The sprocket 15 is located above the stationary cover 10 but the gear mechanism below.

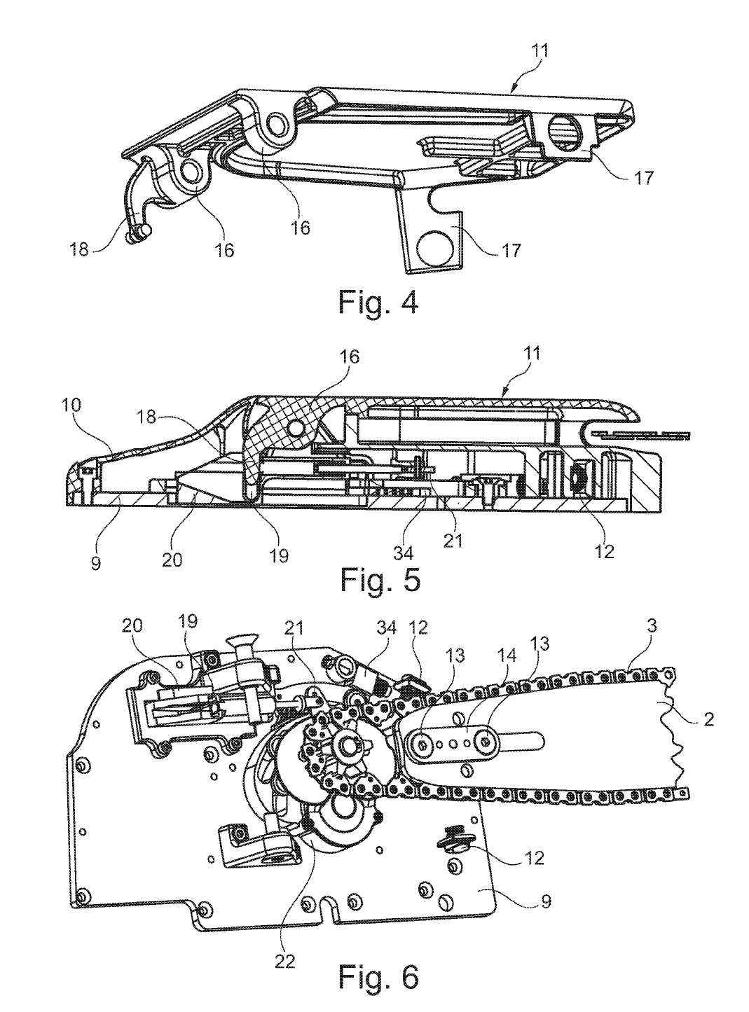

FIG. 4 shows the hinged cover 11 with two barrels 16 for forming a barrel hinge at the rear end of the hinged cover 11, and two lugs 17 at the front end for cooperation with the locking buttons 12. At its rear end, the hinged cover 11 also has a projecting arm 18 for maneuvering the gear transmission of the quick action device. As shown in FIG. 5, the free end of the arm 18 projects into a recess 19 provided at one end of a push/pull rod member 20, which is axially movable parallel to the base plate 9.

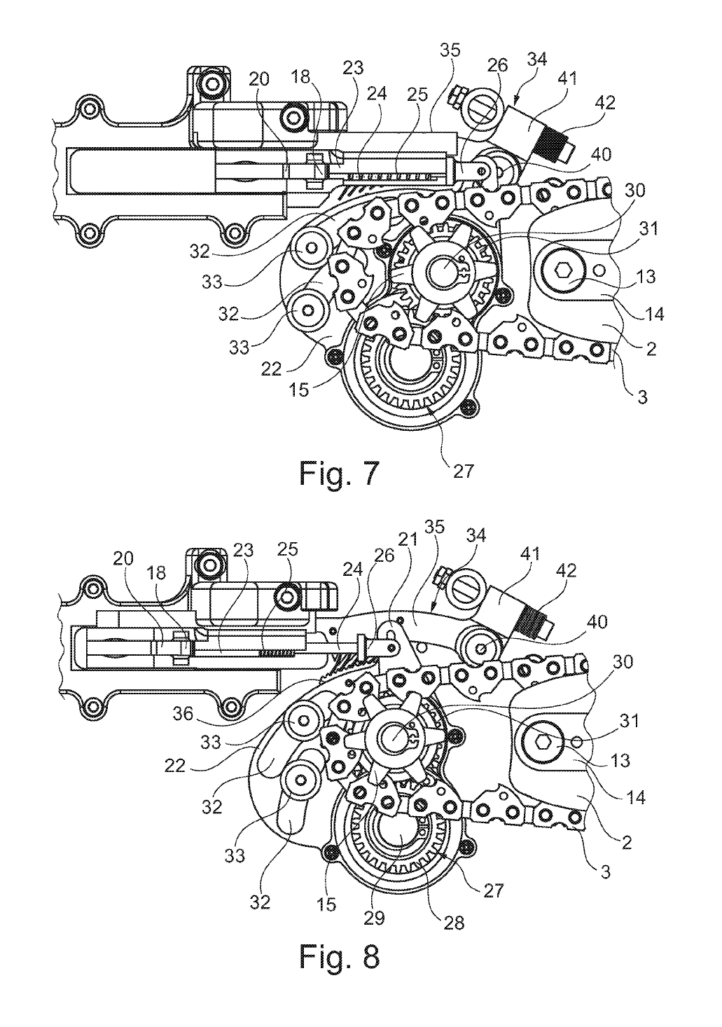

As is best shown in FIGS. 6-8, the other end of the push/pull rod member 20 is pivotally connected to a lug 21 provided on a pivotal housing 22 containing the gear transmission. The housing 22 is pivotal on an axis that is identical with the rotation axis of the output shaft 29. The push/pull rod member 20 includes an axially movable cylinder member 23, and a cap screw 24 having a head located inside the cylinder member 23 and a shank extending through an end of the cylinder member 23 and having a threaded end. A helical compression spring 25 is located between the screw head and said end of the cylinder member 23 and surrounds the shank coaxially. The threaded end is screwed into a connector 26, here a forked connector, which connects the push/pull rod member 20 to the lug 21 on the pivotal housing 22. The compression of the spring 25 is adjustable by rotating the screw 24 until a desired compression is obtained. In this way, the length of the push/pull rod member 20 and the compression of the spring 25 are at a maximum when the hinged cover 11 is closed and the arm 18 has pulled the cylinder member 23 to an end position shown at the left hand side of FIG. 8. At this position the compression spring 25 urges the screw 24 in a direction away from the guide bar 2 providing a pre-tension of the chain 3 by urging the pivotal housing 22 to an anti clock wise rotation, thereby biasing the drive sprocket 15 in a direction away from the guide bar 2 ensuring at least a minimum tension of the chain at start of the chain saw. Thus the pivotal housing 22, the cylinder member 23, the screw 24, and compression spring 25 forms a pre-tensioning mechanism ensuring that the sprocket 15 is in a meshing position with the chain 3 when starting the saw, enabling the automatic tensioning mechanism described below to be activated. Likewise, the length of the push/pull rod member 20 and the compression of the spring 25 are at a minimum when the hinged cover 11 is open and the arm 18 has pushed the cylinder member 23 to an end position shown at the right hand side of FIG. 7. If desired, the assembly including the hinged cover 11 and the push/pull rod member 20 may be used separately, i.e. with or without being supplemented with an automatic chain tensioning mechanism, and it may also be used with or without a pawl and ratchet mechanism that maintains the tension of the chain 3 on reduction of speed of the chain.

In accordance with the present invention, the gear transmission 27 in a first preferred embodiment shown in FIGS. 7 and 8 includes a first gear 28 fixed on the output shaft 29, a second shaft 30, on which the sprocket 15 is mounted, a second gear 31 mounted coaxially with the sprocket 15 and operatively connected thereto on the second shaft 30, and a support device that is pivotal on a rotation axis of the output shaft 29 and carries the second shaft 30 for pivotal movement of the sprocket 15 substantially in a longitudinal direction of the guide bar 2. In the embodiment shown in FIGS. 6-8, the pivotal housing 22 is the support device, and the first and second gears 28, 31 are in direct meshing engagement with each other. To assist in the guiding of the pivotal movement of the housing 22, two elongate curved guide slots 32 are provided in the pivotal housing 22, and a guide follower 33 is located in each slot 32 and fixed to the base plate 9.

The output shaft 29 and hence the first gear 28 is rotated counter clockwise when running the engine. If the sprocket 15 which is coaxially mounted with the second gear 31 to some extent is prevented to rotate, the tangential force from the mesh between the first gear 28 and the second gear 31 will urge the pivotal housing 22 towards a counter clockwise movement around the first gear 28, which moves the sprocket 15 away from the guide bar and thereby tensioning the chain. Thus the arrangement described above provides a design, where forces, which result in the gear transmission 27 due to resistance from rotating the sprocket when running the chain saw, act to displace the sprocket 15 away from the guide bar 2 so as to tension the chain 3. When running without load the resistance mainly comes from friction between guide bar 2 and the chain 3 and when running with load the resistance mainly comes from friction between the object to be cut and the chain 3. Also inertia from acceleration may increase the resistance. Thus, these forces automatically tension the chain 3. As a consequence, a chain running at normal cutting speed will always have the desired tension, but a reduction of the chain speed will reduce the tension in the chain. Therefore, a chain tension maintaining mechanism 34 is provided, which ensures that the tensioning of the chain 3 is maintained even when speed is lowered and furthermore it does not have to start from zero or a very low tension at each start of the chainsaw. The pre-tensioning mechanism 22-25 do provide a tension sufficiently large to ensure meshing of the drive sprocket 15 with the chain 3 at start of the chain saw and could if the chain tension maintaining mechanism 34 were not provided at least handle gentle speed reductions (of course a stronger spring may handle larger speed reductions).

However, the chain tension maintaining mechanism 34 is especially useful when the running chain 3 is stopped suddenly, as it prevents the chain 3 from leaving the guide bar 2, e.g. at a kickback situation, when the front handguard 7 brakes the chain 3 to a standstill. In the shown embodiments, the chain tension maintaining mechanism is a ratchet mechanism 34.

In principle, a ratchet mechanism may include a round gear or linear rack with teeth, and a pivoting, spring operated finger called a pawl that engages the teeth. The teeth are uniform but asymmetrical, with each tooth having a moderate slope on one edge and a much steeper slope on the other edge. When the teeth are moving in the unrestricted, the pawl easily slides up and over the gently sloped edges of the teeth, with a spring forcing it into the depression between the teeth as it passes the tip of each tooth. When the teeth move in the opposite direction, however, the pawl will catch against the steeply sloped edge of the first tooth it encounters, thereby locking it against the tooth and preventing any further motion in that direction.

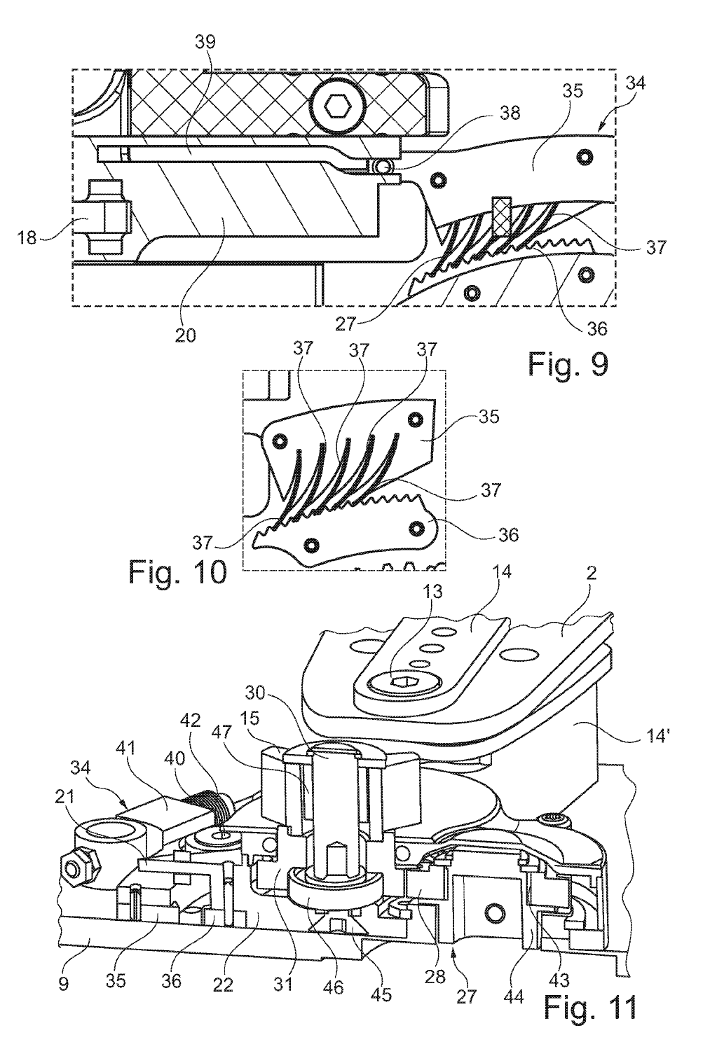

In the embodiment best shown in FIGS. 7-10, the ratchet mechanism 34 comprises a pivotal pawl carrying atm 35 and a cooperating toothed rack 36. The rack 36 is curved and mounted on the pivotal housing 22, and the pivotal arm 35 has a series of pawls 37, in the shown embodiment five blade-shaped pawls, which at normal running conditions are pressed against the rack 36 as shown in FIGS. 9 and 10. FIG. 9 also shows that the pawl-carrying pivotal arm 35 at its free end (to the left in FIG. 9) has a guide pin 38, which on axial movement of the push/pull rod member 20 will move along a guide groove 39 provided in the push/pull rod member. Thereby, on opening the hinged cover 11, the movement of the push/pull rod member 20 will pivot the pawl carrying arm 35 aside, so that the blade-shaped pawls are lifted out of engagement with the toothed rack 36, the sprocket 15 is free to move toward the guide bar 2 and the chain 3 is easy to remove. If desired, the spacing between the pawls may differ from that between the teeth. Thereby, the locking of the pivotal movement of the pivotal housing 22 can be achieved at smaller steps than the spacing of the teeth.

When the chainsaw is cutting, the chain 3 gets hot and increases its length by thermal expansion. This is no problem, as the sprocket 15 moves away from the guide bar 2 to tension the chain 3. However, when a break is made in the cutting, the chain cools and gets shorter and the chain tension is increased, and the sprocket 15 tries to move back toward the guide bar 2, but is prevented from doing so by the ratchet mechanism 34. The pawl-carrying pivotal arm 35 has an oblong hole for an associated pivot shaft 40, so that the arm 35 can be displaced sufficiently in its longitudinal direction, substantially corresponding to the direction of the longitudinal axis of the guide bar, to compensate for the length reduction of the chain 3 upon cooling from maybe 70° C. to 20° C., for example. The cooling chain 3 pulls the sprocket 15 and the toothed rack 36 toward the guide bar 1, thereby increasing the load on the pawls 37. The oblong hole reduces that load by permitting the longitudinal displacement of the pawl-carrying pivotal arm 35. Adjacent the oblong hole, the pawl carrying arm 35 has a short generally perpendicular arm 41, which is biased by springs 42, so as to return the pawl carrying arm 35 to its original position as soon as possible. Alternatively the pawl-carrying pivotal arm 35 could be connected to a thermally responsive material such as bimetallic strips or disks, which convert a temperature change into a mechanical displacement.

FIG. 11 is a cross sectional view showing the two-gear transmission and a surrounding pivotal housing mounted on a base plate. In the shown embodiment, the first gear 28 is fixed to the output shaft (not shown) by means of an adapter 43 and a friction clutch tolerance ring 44, the second shaft 30 is fixed in the pivotal housing 22 by means of an axial screw 45, the second gear 31 is journalled on the second shaft 30 by a rolling bearing 46, and the sprocket 15 is mounted on the second shaft 30 by means of a needle bushing 47. Further, the second gear 31 has a polygonal axial recess and the sprocket 15 has a corresponding polygonal axial projection for drivingly connecting the second gear 31 to the sprocket 15.

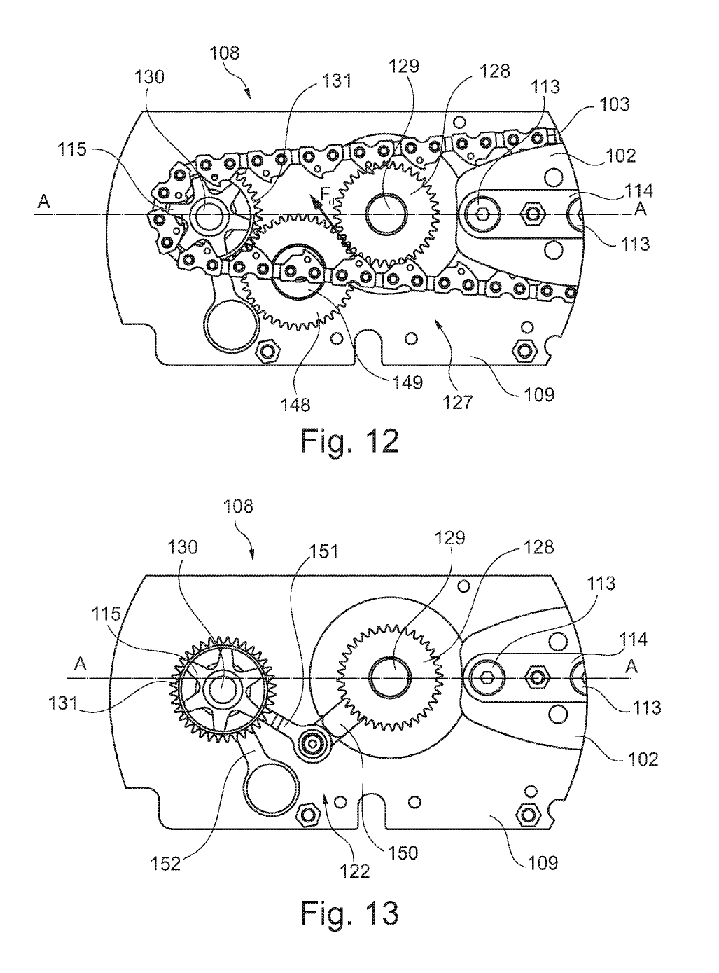

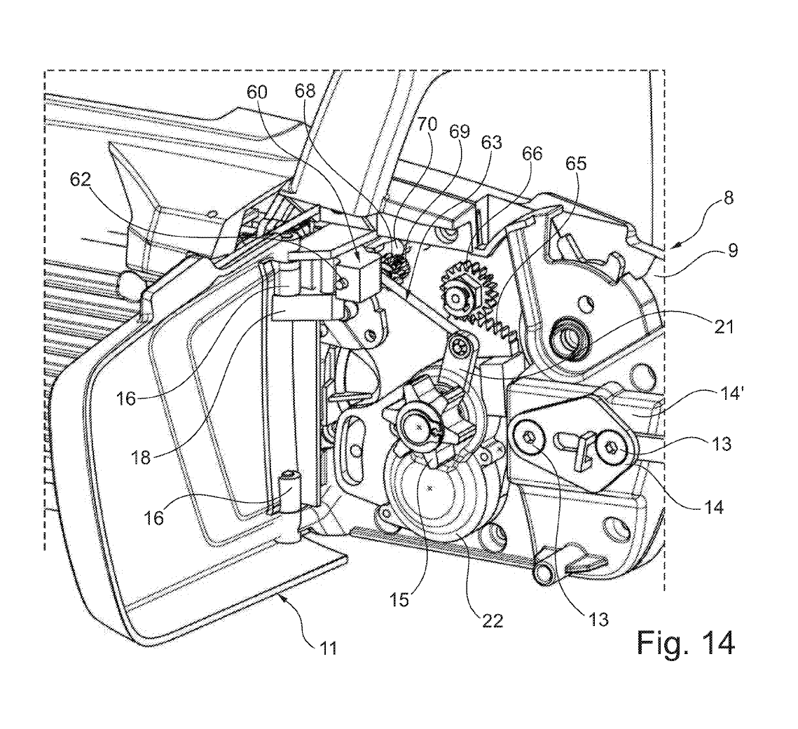

The embodiment shown in FIGS. 12 and 13 has many features in common with the embodiments described above. Where possible, the reference numerals used in FIGS. 12 and 13 are the same as those used in FIGS. 1-11 but selected from the 100-series. Thus, guide bar 2 becomes guide bar 102, and so forth.

In the embodiment shown in FIGS. 12 and 13, the gear transmission 127 in addition to a first gear 128, which is mounted on and driven by an output shaft 129, and a second gear 131, which is mounted on a second shaft 130 and drives the sprocket 115, further includes an intermediate third gear 148 mounted on a third shaft 149 carried by the support device 122 and meshing with the first gear 128 and the second gear 131 to transmit rotation of the first gear 128 to the second gear 131 and thus to drive the sprocket 115.

While FIG. 12 shows the assembly 108 when the chain 103 is running at normal cutting speed, in FIG. 13, the chain 103 has been brought to a standstill and removed, and also the intermediary third gear 148 is removed to make it possible to view details otherwise hidden. The support device 122 includes a first link 150 maintaining a predetermined distance between the output shaft 129 and the third shaft 149, a second link 151 maintaining a predetermined distance between the third shaft 149 and the second shaft 130, and a pivotal third link 152 having an end, which is fixed to the base plate 109, and an opposite end that carries the second shaft 13. The first link 150 and second link 151 form a variable angle elbow to permit the sprocket 115 to move toward or away from the output shaft 129. When running the chain saw the drive shaft 129 with the first gear 128 is arranged to rotate clockwise. If the sprocket 115 to some extent is prevented to rotate, the tangential forces between the first and the third gears 128, 148 and the third and the second gears 148, 131, urges the second gear 131 and this the sprocket 115 in a direction away from the guide bar 102. In this way, the sprocket 115 is mounted to be displaceable in a direction away from the guide bar 102 by the forces which result in the gear transmission 127 due to resistance from rotating the sprocket 115, when the chain saw is running. The output shaft 129 with the first gear 128 is preferably located between the guide bar 102 and the sprocket 115, and is substantially on a level with them (line A-A in FIG. 12).

Further, like in the embodiment of FIGS. 1-11, the assembly 108 shown in FIGS. 12 and 13 preferably includes a chain tension maintaining mechanism, such as a ratchet mechanism, not shown, which prevents the sprocket from being displaced toward the guide bar and thereby ensures that the tensioning of the chain does not have to start from zero or a very low tension at each start of the chainsaw. Further, the chain tension maintaining mechanism is especially useful when the running chain is stopped suddenly, as it prevents the chain from leaving the guide bar, e.g. at a kickback situation, when the front hand guard brakes the chain. Although the chain tension maintaining mechanism is not shown, a person skilled in the art can easily and without inventive effort apply the teachings relating to such mechanism from FIGS. 7-10 to the embodiment shown in FIGS. 12 and 13.

Still further, like in the embodiment of FIGS. 1-11, the assembly 108 shown in FIGS. 12 and 13 preferably but not necessarily includes pre-tensioning mechanism that is operatively connected to the drive sprocket 115 and biasing the drive sprocket 115 in a direction away from the guide bar 102 to ensure that at least a minimum tension of the chain is provided at start of the chain saw. The pre-tensioning mechanism may be e.g. in the form of a spring acting between the output shaft 129 and the guide bar, or between the third shaft 149 and the base plate 109.

Still further, like in the embodiment of FIGS. 1-11, the assembly 108 shown in FIGS. 12 and 13 preferably but not necessarily includes a hinged cover similar to cover 11 and a cooperating push/pull rod member similar to push/pull rod member 20, none of which is shown. In the embodiment of FIGS. 12 and 13, the hinged cover suitably is located at the top of the base plate, and the push/pull rod member extends from the arm carried by the cover at its hinge axis to the elbow joint between the first link 150 and the second link 151. On opening the cover, the push/pull rod member displaces the third gear 148 (downward in the Figs.), whereby the sprocket 115 is displaced in a direction toward the guide bar 102 to reduce the tension in the chain 103, thereby making it easy to demount the chain 103 from the saw when the hinged cover is open. Similarly, on closing the cover, the arm on the cover pulls the push/pull rod member to make the third gear 148 move (upward in the Figs.) and displace the sprocket 115 in a direction away from the guide bar 102 to pre-tension the chain 103. Although the hinged cover with its arm and the push/pull rod member are not shown, a person skilled in the art can easily and without inventive effort apply the teachings relating thereto from FIGS. 7-8 to the embodiment shown in FIGS. 12 and 13.

Further, in the embodiment of FIGS. 12 and 13, the third link 152 may be replaced by having the second shaft 130 guided in a guide groove extending substantially in the longitudinal direction of the guide bar 102.

Obviously the push/pull rod member 20 could be made to employ a tension spring instead of the compression spring 25. In such case an opening of the cover 11 compresses the push/pull rod member 20 and the tension spring axially, while a closing of the cover 11 extends the push/pull rod member 20 and the tension spring.

Naturally, if desired it is possible to use the lever (hinged cover 11) operated quick-action device in combination with another type of chain tensioning mechanism than one of the two automatic chain tensioning mechanisms described above with reference to the drawings.

Obviously the automatic chain tensioning mechanism can be used in combination with a quick-action device displacing the guide bar 102 instead of the sprocket 15.

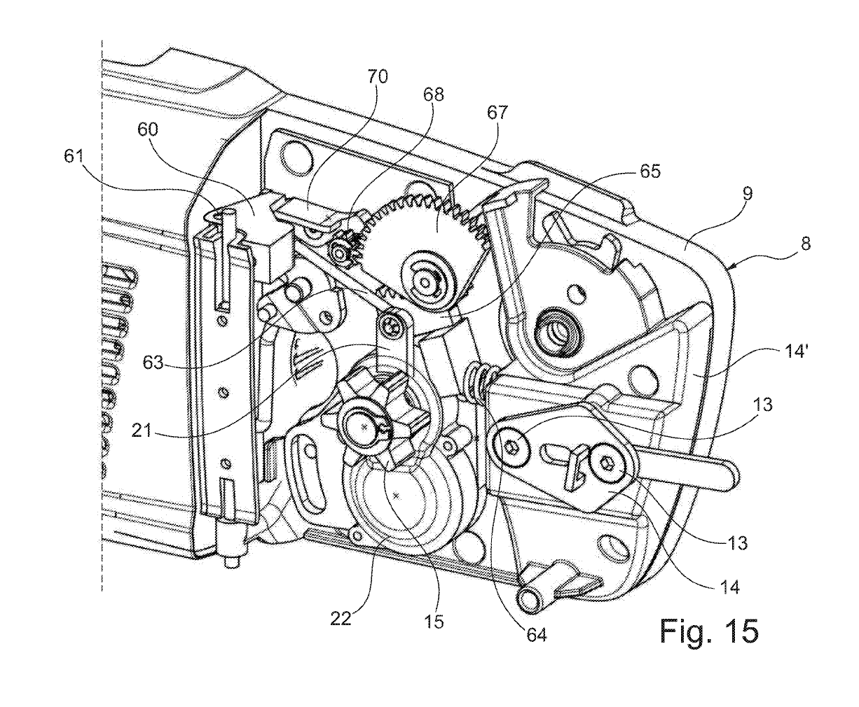

In the embodiment shown in FIGS. 14 and 15 the saw chain 3, the guide bar 2 and in FIG. 15 the hinged cover 11, for example, are not shown, but to improve the clarity in the description below, also components that are not shown will retain their reference numerals.

FIGS. 14 and 15 show an assembly 8 incorporating a quick action device in accordance with another preferred embodiment of the present invention for demounting the chain from the saw as well as automatically tensioning the chain in the saw of FIG. 1. The assembly includes a base plate 9, a gear transmission in a pivotal housing 22 carried by the base plate 9 for transmitting the rotation of the output shaft to the displaceable sprocket 15 that upon pivoting of the pivotal housing 22 displaces the sprocket 15 toward and away from the guide bar, and a hinged cover 11 pivotally attached to the base plate 9 and shielding the sprocket and adjacent portions of the chain 3. The hinged cover 11 is hinged at its rear end, distal from the guide bar 2, where it has two barrels 16 for forming a barrel hinge. At its rear end, the hinged cover 11 also has a projecting arm or bracket 18 for maneuvering the gear transmission of the quick action device. The top side of the arm or bracket 18 is horizontal and carries a pivot slide 60, which can rotate around a vertical shaft 61 (FIG. 15) carried by the arm or bracket 18, so that the pivot slide 60 maintains its orientation on opening or closing of the hinged cover 11 and accompanying angular movement of the projecting arm or bracket 18.

Like in the above embodiments, by means of two screws 13 and an intermediate assembling plate 14, the guide bar 2 is secured to a guide bar adapter (14′, shown in FIG. 11), which is secured to the base plate 9.

One leg of a generally U-shaped push/pull rod member 63 is inserted in a horizontal bore 62 in pivot slide 60. The other leg of the generally U-shaped push/pull rod member 63 is pivotally connected to the lug 21 provided on the pivotal housing 22, which contains the gear transmission. The housing 22 is pivotal on an axis that is identical with the rotation axis of the output shaft 29. On opening and closing the hinged cover 11, the pivot slide 60 moves in an arc around the hinge axis, but since the rear leg of the generally U-shaped push/pull rod member 63 is inserted in the horizontal bore 62 in pivot slide 60, the orientation of the pivot slide 60 relative to other components of the chainsaw, except for the hinged cover 11, will not change. On opening the hinged cover 11, the orientation of the pivot slide 50 is maintained by the rear leg of the generally U-shaped push/pull rod member 63 and thus caused to rotate on the top surface of the moving arm or bracket 18 to maintain its orientation. Further the opening the hinged cover 11 causes the pivot slide 50 to move along a circular arc around the hinge axis of the cover 11, whereby the pivot slide 50 moves toward the guide bar and via the generally U-shaped push/pull rod member 63 pivots the pivotal housing 22 to move the sprocket 15 toward the guide bar, so as to reduce the tension in the chain. On closing of the hinged cover 11, the respective movements of the components associated with the opening are reversed. A helical compression spring 64 (FIG. 15) is located between the guide bar adapter 14′ and the pivotal housing 22 to assist in the pivoting of the housing 22 on closing the hinged cover 22 and to keep the saw chain 3 tensioned incessantly when the hinged cover 11 is closed. The helical compression spring 64 and the pivotal housing 22 providing a pre-tensioning mechanism that is operatively connected to the drive sprocket 15 and biasing the drive sprocket 15 in a direction away from the guide bar to ensure at least a minimum tension of the chain at start of the chain saw. I.e. ensuring that the sprocket 15 is in a meshing position with the chain 3 when the chain saw is started, thereby enabling the automatic tensioning mechanism described below to be activated. If desired, the helical compression spring 64 may be located between the pivotal housing 22 and some other fixed part of the saw than the guide bar adapter 14 helical compression spring 64.

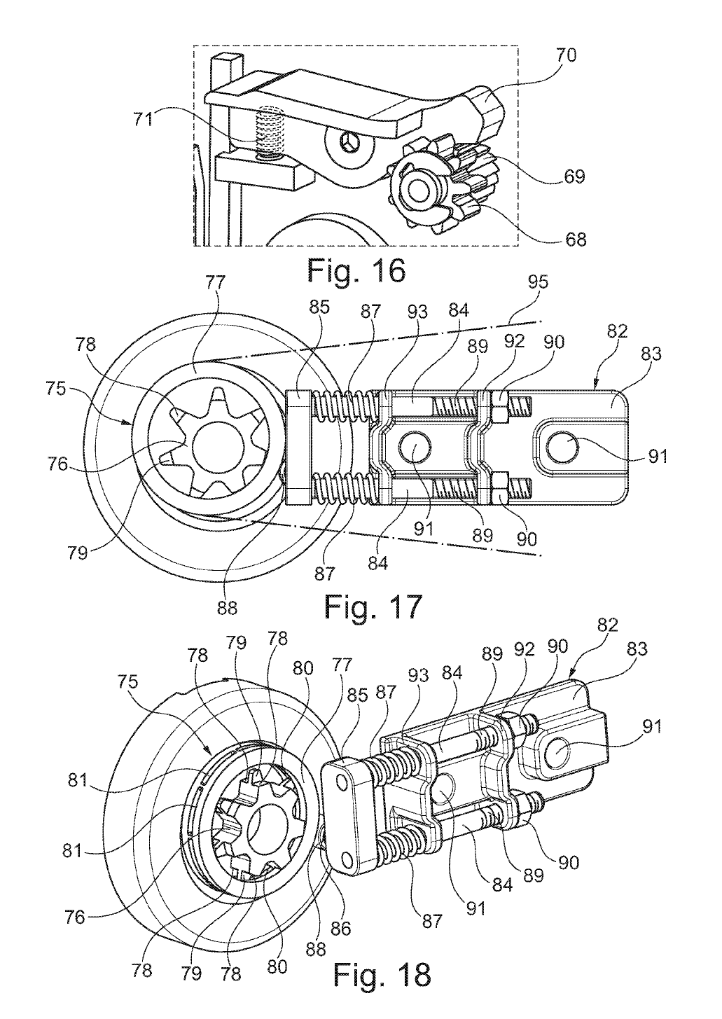

A first rack 65 in the shape of a gear section is fixed to or integral with the pivotal housing 22 and engages the teeth of a first pinion 66. A second rack 67 in the shape of a gear section (invisible in FIG. 14 but shown in FIG. 15) is coaxially fixed to or integral with the first pinion 66 and engages the teeth of a second pinion 68. A ratchet wheel 69 is coaxially fixed to or integral with the second pinion 68. A pivotal pawl 70 shaped as a two-armed lever is biased by a spring 71 to engage the ratchet wheel 69. The pawl and ratchet mechanism 69-71 is best shown in FIG. 16. Thus, the pawl 70 has one end, which upon lowering or rising causes the other end to move in the opposite direction to bring the pawl 70 into or out of engagement with the ratchet wheel 69. The teeth of the ratchet wheel 69 are of a shape such that when the pawl 70 engages the ratchet wheel 69, the pivotal housing 22 is prevented from moving toward the guide bar 2 but permitted to move in the opposite direction. The pawl 70 is operated by the movement of the pivot slide 60. When the hinged cover 11 is closed (FIG. 15), the position of the pivot slide 60 enables the pawl 70 to engage the ratchet wheel 69 and prevents the saw chain 3 from slackening, but on opening the hinged cover 11 (FIG. 14), the pivot slide 60 on moving toward the pivot axis of the pawl 70 presses down the rear lever arm thereof so as to lift the opposite end of the pivotal pawl 70 out of engagement with the ratchet wheel 69. If desired, it may be possible to cancel the first pinion 66 and the second rack 67 and make the first rack 65 engage the second pinion 68 directly.

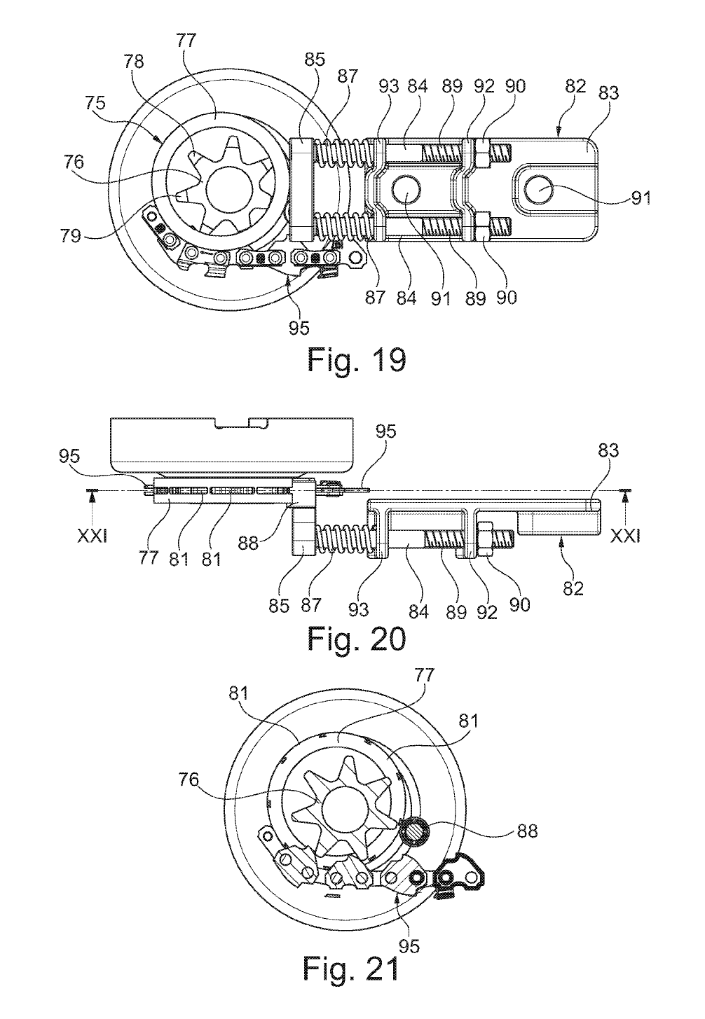

Still another embodiment of a mechanism for automatically tensioning the chain of a chainsaw is illustrated in FIGS. 17-21. In this embodiment, a saw chain as usual runs on a guide bar for guiding the chain. The guide bar is not shown, and the chain is indicated by a dashed and dotted line 95 in FIG. 17, but a section of the chain 95 is shown in FIGS. 19-21. The mechanism includes a sprocket assembly 75 for driving the saw chain 95. The sprocket assembly 75 includes an inner driving sprocket 76, and an outer loose ring member 77 surrounding the inner sprocket 76 and having a radially inner side shaped to be supported thereby and a radially outer side shaped to engage the saw chain 95 for supporting and guiding it. The driving sprocket 76 is driven by an output shaft (not shown) of the engine (not shown).

In the preferred embodiment shown in the drawings and as is best shown in FIG. 18, the teeth of the driving inner sprocket 76 have the axially outer top portions of each tooth removed, so that a load carrying shoulder 78 is formed on each side of a central top portion 79 of each tooth, and the top portions 79 extend into recesses 80 formed in the radially inner side of the outer loose ring member 77 to enable the inner sprocket 76 to carry the load from the tensioned saw chain 95. In the radially outer side of the ring member 77, recesses 81 are formed for receiving conventional drive links of the saw chain 95. In the shown embodiment, the recesses 80 and 81 on the outside and the inside of the ring member 77 meet, so that through holes are formed, and as is best shown in FIGS. 20 and 21, the ring member 77 comprises two axial halves interconnected by rung-like members like in a ladder, so that the space formed between the two halves constitute the radial through holes for the inwardly extending portions of drive links for driving engagement with the top portions 79 of the teeth of the inner sprocket 76. However, if desired, the recesses 80 and 81 in the ring member 77 may be bottom recesses or still form through holes, such that the inner sprocket drives the ring member 77, which in turn drives the saw chain 95. Alternatively, in an embodiment not shown, a pinion and a ring gear meshing with the pinion may be substituted for the inner sprocket 76 and the ring member 77, respectively, provided that the radially outer surface of the ring gear is shaped to engage the inwardly extending portions of the drive links for driving the saw chain.

Upon starting the engine, the forces between the inner sprocket 76 and the outer ring member 77 will cause an angular displacement of the outer ring member 77 around the inner sprocket 76 and thereby tension the saw chain 95 automatically. From a physical point of view, action equals reaction and the tension depends on the resistance met with.

A pre-tensioning mechanism 82 is provided for pressing the ring member 77 (instead of the pivotal housing 22 of FIGS. 14 and 15) against the inner sprocket 76 in a manner such that at least a minimum tension in the saw chain 95 is ensured. The pre-tensioning mechanism 82 suitably includes a holder 83 (instead of the adapter 14′ in FIGS. 14 and 15) adapted to be attached to a rear end of the guide bar, and two parallel rods 84 mounted movably on the holder 83 and extending side by side in the direction of the guide bar. The holder 83 has two through bores 91 for the passing there through of the two conventional screws for attaching the guide bar to the chainsaw. The two rods 84 are axially movable in a front bracket 92 and a rear bracket 93 that are integral with the holder 83. Each rod 84 has a portion extending rearward from rear bracket 93 and in addition an end located proximate the ring member 77. The two rod ends are interconnected by a cross piece 85, and the cross piece 85 has a projecting member 86 adapted to contact the radially outer side of the ring member 77. Helical compression springs 87 (instead of spring 64 in FIG. 15) are mounted around said portions of the rods 84 to press the projecting member 86 against the radially outer side of the ring member 77 and thereby maintain tension in the saw chain 95 and driving engagement between the sprocket 76 and the saw chain 95. Such a mechanism is simple and reliable.

The projecting member 86 may be in sliding contact with the outer circumference of the ring member 77, but preferably the projecting member 86 includes a rotary wheel 88 to reduce friction and wear, more preferably the projecting member 86 includes a needle roller bearing.

It is also preferred that the rods 84 have distal ends provided with a threaded portion 89 and a nut 90 screwed onto the threaded portion 89 and tightened against the front bracket 92 for pre-tensioning the compression springs 87 between the rear bracket 93 and the cross piece 85.

To ensure that the chain 95 does not slacken when it is not running, the mechanism 82 suitably presses the ring member 77 against the inner sprocket 76 below the center of the sprocket 76 to push the ring member 77 upwards to get as much mesh with the chain 95 and sprocket 76 as possible when pre-tensioning the chain. Substantially at a four o'clock position in relation to a rotational axis of the inner sprocket 76, when the guide bar extends outward from a three o'clock position and the saw chain 95 is returned to the sprocket assembly 75 along a bottom side of the guide bar. The four o'clock position is defined as the point of intersection between an extended radius from a rotational axis of the inner sprocket 76 and the radially outer surface of the ring member 77, when an angle of approximately 30° is formed between a line, which is parallel to a longitudinal axis of the guide bar and extends through the rotational axis of the inner sprocket 76, and said extended radius when the radius is rotated clockwise downwards from said line.

In the embodiment of FIG. 17-21 the inner sprocket 77 functions as a first gear and meshing with the ring member 77 that functions as a second gear. The gears form a gear transmission that due to resistance from rotating the ring member 77 automatically tensions the chain.

The embodiment of FIG. 17-21 suitably has a chain tension maintaining mechanism that upon reduction of the speed of a running chain 95 maintains the chain tension by preventing the ring member 77 from moving toward the guide bar. Such chain tension maintaining mechanism can e.g. be implemented by a ratchet mechanism operatively connected to the rods 84 and/or the cross piece 85, preventing it from being moved towards the guide bar unless the ratchet lock is released.

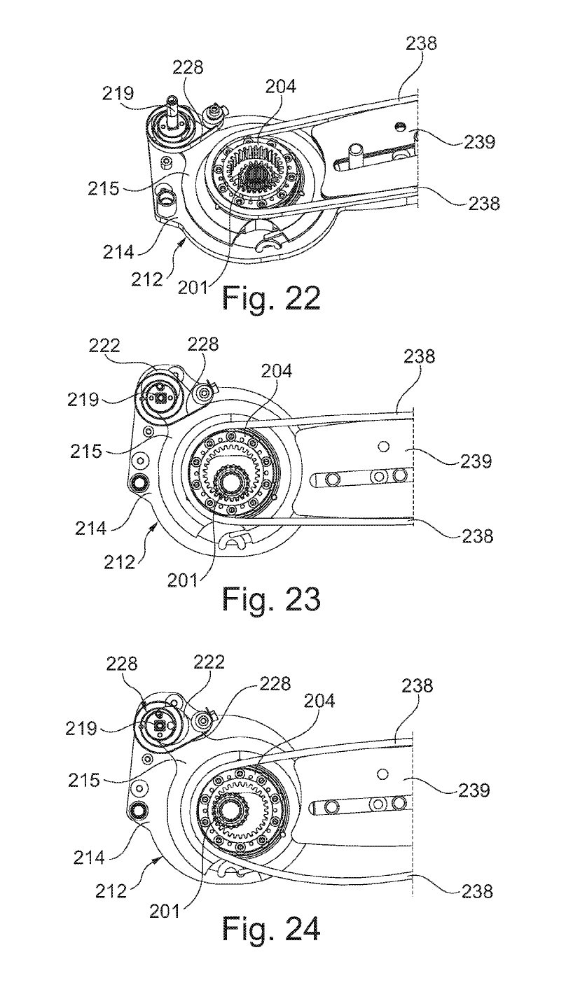

FIGS. 22-27 illustrate still another preferred embodiment of the automatically tensioning mechanism of the present invention. In FIGS. 22-24, a clutch drum assembly is removed from the mechanism to show the components that otherwise would be hidden behind the clutch drum assembly.

The embodiment of FIGS. 22-27 also includes a ring member 204 but which here, in addition to guiding and supporting the chain, also drives the chain, i.e. the ring member 204 is acting as drive sprocket. The ring member 204 also functions as a second gear, being driven by a first gear 201, by having an inner toothed ring 207 that can mesh with the first gear 201. The ring member/drive sprocket 204 surrounds the first gear 201 and has an inner diameter large enough to provide a loose fit around the first gear 201. The first gear 201 and the inner toothed ring 207 have meshing teeth arranged to form a smaller pitch circle and a larger pitch circle, respectively, none of which are shown. A device 212 is provided for allowing a center of the ring member/drive sprocket 204 to move along a restricted angular path formed by a periphery of a semicircle around a center of the first gear 201, said semicircle having a diameter that is equal to a difference in diameter between the two pitch circles.

FIGS. 22 and 23 show the device 212 tensioning the saw chain 238 around a guide bar 239 as is the case when the engine drives the chain or the operator does not any longer press a trigger that controls the engine RPM.

Upon starting the engine, the forces between the first gear 201 and the second gear 207 of the ring member/drive sprocket 204 will cause an angular displacement of the ring member/drive sprocket 204 around the first gear 201 and thereby tension the saw chain 238 automatically. From a physical point of view, action equals reaction and the tension depends on the resistance met with.

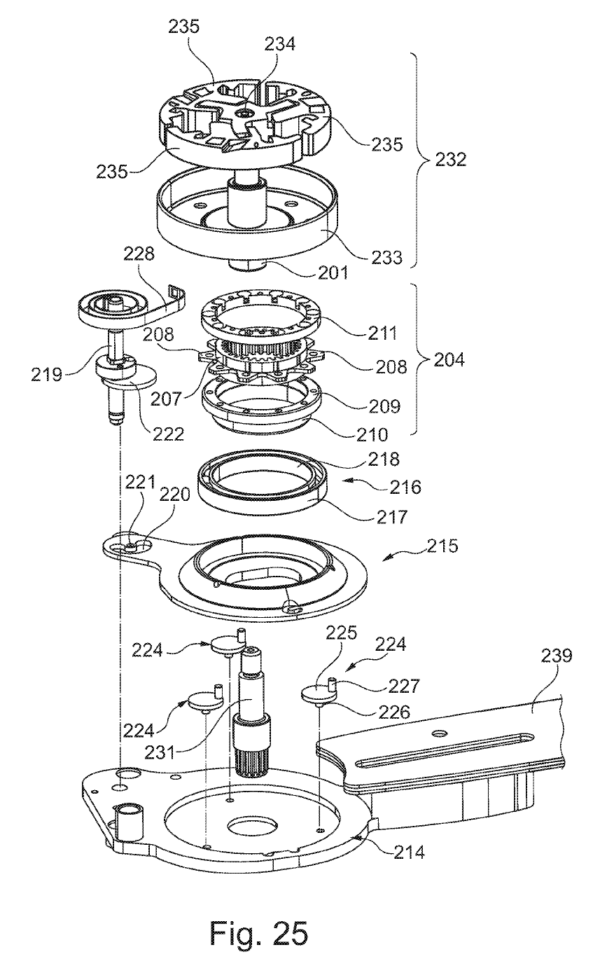

With reference to FIG. 25, the device 212 for providing the semicircular movement preferably comprises:
a) a chainsaw platform 214 that is integral with or adapted to be fixed to a chainsaw housing;
b) a slide plate 215 that is carried by and movable in relation to the chainsaw platform 214;
c) a rolling-element bearing 216 having an outer race ring 217 and an inner race ring 218 and having one of the race rings fixed to the slide plate 215, said ring member/drive sprocket 204 being fixed to the other race ring;
d) a rotary shaft 219 carried by the chainsaw platform 214 and extending through a semicircular opening 220 in the slide plate 215, said shaft 219 being operatively connected to the slide plate 215 to move it upon rotation of the shaft 219;
e) a plurality of eccentric bearings 224 connecting the slide plate 215 to the chainsaw platform 214 to restrict the movement of the slide plate 215 to movements along said semicircular path; and
f) a spring member 228 having one end attached to the chainsaw platform 214 and the other end to the shaft 219 in such a manner that the slide plate 214 with the outer ring member 204 maintain the saw chain 238 pre-tensioned.

In this embodiment, the device 212 functions a pre-tensioning mechanism that is operatively connected to the ring member/drive sprocket 204 and biasing the ring member/drive sprocket 204 in a direction away from the guide bar to ensure that at least a minimum tension of the chain is provided at start of the chain saw

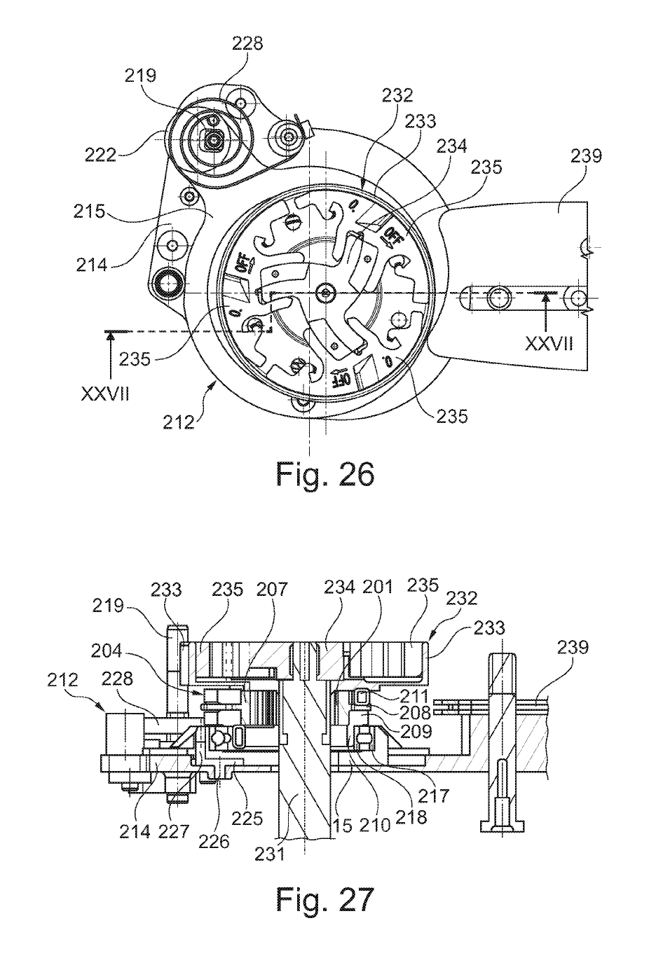

Further, FIG. 25 shows the drive shaft 231 adapted to be connected between the engine and a clutch drum assembly 232. However, if desired the drive shaft 231 could be integrated in the crankshaft of the engine. As is best shown in FIGS. 26 and 27, the clutch drum assembly 232 includes a clutch drum 233, a rotor 234 driven by the drive shaft 231, and a plurality of clutch shoes 235—in the shown embodiment three shoes—engaged by the rotor 234 and pressed outward against an interior wall of the clutch drum 233 upon rotation of the rotor 234 at a sufficiently high RPM. The clutch shoes 235 are connected to one another other by means of tension springs, not shown, so that they will not engage the clutch drum wall until pressed outwards by a centrifugal force caused by the rotating rotor 234. The first gear 201 is fixed to or integral with the clutch drum 233 and rotates together with it. Since the drive shaft 231 extends through the first gear 201, a needle bearing, not shown, is provided there between. In the shown embodiment, the clutch drum assembly 232 is positioned axially outside the ring member/drive sprocket 204 but, if desired, it is possible to place it on the opposite side, between the engine and the ring member/drive sprocket 204. In the embodiment shown in the Figs., the outer race ring 217 is seated in the slide plate 215 while the ring member/drive sprocket 204, or more precisely a bottom ring member 209 included in the ring member/drive sprocket 204, has a sleeve 210 that is seated in the inner race ring 218.

In addition, FIG. 25 shows that the eccentric bearings 224 may be eccentric disks 225 having a central pin 226 on one side and an eccentrically placed pin 227 on the opposite side. A bore 221 is provided in the center of the semicircle forming the opening 220 for the rotary shaft 219 in the slide plate 215. An eccentric member 222 is fixed on the rotary shaft 219 and has an eccentrically located pin (not shown) engaging the bore 221. Upon rotation of the rotary shaft 219, the slide plate 215 will perform a movement along a semicircle defined by the semicircular opening 220. This will move the point of meshing contact between the first gear 201 and the ring/member drive sprocket 204. The spring member 228 rotates the rotary shaft 219 to pre-tension the chain 238, what makes the slide plate 215 move so that the position of the rotary shaft 219 in the semicircular opening 220 will move in a direction from one end of the opening 220 toward the other end. Further, the spring member 228 is pre-tensioned and the pre-tension force may be adjusted by attaching the spring member 228 at various positions around the circumference of the rotary shaft 219.

In FIGS. 22 and 23, the saw chain 238 is tensioned and the point of meshing contact is located in a six o'clock position, and the rotary shaft 219 is located halfway between the two ends of the semicircular opening 220. In FIG. 24, the kickback brake of the chainsaw has just been triggered, the chain 238 has stopped immediately, and due to the inertia of the moving chain, the ring member/drive sprocket 204 has been pulled toward the guide bar 239 along a semicircular path, and the point of meshing contact now is located in the nine o'clock position. Of course, this only happens if there is no chain tension maintaining mechanism that upon reduction of the speed of a running chain maintains the chain tension by preventing the ring member/drive sprocket 204 from moving toward the guide bar. If desired a chain tension maintaining mechanism can of course be provided such as e.g. a ratchet mechanism. Simultaneously, the slide plate 214 will move, so that the rotary shaft 219 will be positioned at one of the ends of the semicircular opening 220, thereby tensioning the pre-tension spring 228. Then the pre-tension spring 228 starts relaxing and rotates the rotary shaft 219 to return the slide plate 215 with the outer ring member 204 to its former position, and thereby tensioning the chain 238. As time goes by, the chain 238 gets longer by wear but is kept tensioned by the pre-tension spring 228, so that the point of meshing contact gradually moves toward the three o'clock position.

The ring member/drive sprocket 204 has external teeth 208 for engaging the inwardly extending portions of the drive links of the saw chain 238. If desired, the external teeth 208 may be provided on a central ring 206 that is sandwiched between two rings 209, 211 included in the ring member/drive sprocket 204. Then, the radially outer surface of the two rings 209, 211 form a support surface for the chain, and the spaces defined by the two rings 209, 211 and the external teeth 208 of the ring member/drive sprocket 204 form recesses in the ring member/drive sprocket 204 for receiving the inwardly extending portions of the drive links. Of course, if desired, the ring member/drive sprocket 204 can be made as an integral whole.

Various features of the present invention as described above may be combined in other ways within the scope of the appended claims. As an illustrative example, it would be possible to incorporate the spring 64 of FIGS. 14 and 15 in the embodiment shown in FIGS. 1-11, if desired. Further, it would be possible to substitute a pawl and ratchet mechanism for the pretension spring member 228 in order to avoid too much slackening of the saw chain 238 in case of a stop triggered by a kickback brake.

In the embodiments described in relation to FIG. 1-16, 22-27 the drive sprocket 15; 115; 204 functions as a rotatable chain guiding member guiding the chain in cooperation with the guide bar 2; 102; 239. In the embodiments of FIG. 16-27 the ring member 77 around the drive sprocket 76 functions as rotatable chain guiding member guiding the chain 95 in cooperation with the guide bar. In all embodiments the chain 3; 103; 95; 238 is tensioned by displacing the chain guiding member 15; 115; 77; 204 away from the guide bar 2; 102; 239.

Obviously a quick action device using the cover as a lever arm to displace the chain guiding member for quick mounting/demounting of a chain could be implemented not only in the embodiments of FIG. 1-11 and FIG. 14-15, but rather to all shown embodiments.

The chain tension maintaining mechanism may include a freewheel mechanism allowing rotation in one direction and being operatively connected to the chain guiding member, for instance a ratcheting freewheel mechanism.

### INDUSTRIAL APPLICABILITY

The present invention is applicable where it is desired to provide a quick-action device for demounting a saw chain 3 from a chainsaw, so that the operator easily can remove the chain from the chainsaw, and after substituting another chain 3 for the removed one, pre-tension the new chain 3 automatically. It is also applicable where it is desired to have an automatic tensioning of a chain 3 running at normal cutting speed.

1. A quick-action device for facilitating attachment/detachment of a saw chain of a chainsaw, the chain saw further including a guide bar and a rotatable chain guiding member for guiding the chain, wherein:
a) the chain guiding member is mounted to be displaceable toward and away from the guide bar; and
b) a lever arm is operatively connected to displace the chain guiding member in a directions away from the guide bar upon actuation thereof, thereby facilitating attachment/detachment of the chain from the saw when the chain guiding member is displaced towards the guide bar.

2. A device as claimed in claim 1, wherein the chain saw includes cover covering the chain guiding member and adjacent portion of the guide bar and the chain, said cover being hinged and operating as the lever arm in such manner that the chain guiding member is displaced in a direction towards the guide bar on opening of the hinged cover, and in a direction away from the guide bar on closing the hinged cover, thereby facilitating attachment/detachment of the chain from the saw when the hinged cover is open.

3. A device as claimed in claim 2, further including a ratchet mechanism, which after closing of the cover maintains the chain guiding member in its intended position, and on opening of the cover releases the chain guiding member, thereby releasing the tension in the chain.

4. A device as claimed in claim 1, wherein a spring member is operatively connected between the guide bar and the chain guiding member for biasing the chain guiding member in a direction away from the guide bar so as to maintain the saw chain tensioned unless the lever arm is actuated to move the chain guiding member toward the guide bar.

5. A device as claimed in claim 1, wherein the chain guiding member is the drive sprocket.

6. A device as claimed in claim 1, wherein the chain guiding member is a ring member surrounding the drive sprocket, the ring member having a radially outer side shaped to guide the saw chain.

7. A mechanism for automatically tensioning the chain of a chainsaw, the mechanism including a saw chain, a guide bar and a rotatable chain guiding member for guiding the chain, a driven output shaft, and a gear transmission for operatively connecting the output shaft to the chain guiding member, wherein:
a) the chain guiding member is mounted to be displaceable in a direction away from the guide bar, and thereby apply tension to the chain, by forces that result in the gear transmission due to resistance from rotating the chain guiding member, when the chain saw is driven; and the mechanism including at least one of:
b) a chain tension maintaining mechanism that upon reduction of the speed of a running chain maintains the chain tension by preventing the chain guiding member from moving toward the guide bar,
c) a pre-tensioning mechanism operatively connected to the chain guiding member biasing the chain guiding member in a direction away from the guide bar to ensure that at least a minimum tension of the chain is provided at start of the chain saw.

8. An automatically tensioning mechanism as claimed in claim 7, wherein the gear transmission includes a first gear fixed on the output shaft, and a second gear mounted coaxially with the chain guiding member and operatively connected thereto.

9. An automatically tensioning mechanism as claimed in claim 7, wherein the chain tension maintaining mechanism is a ratchet mechanism.

10. An automatically tensioning mechanism as claimed in claim 9, wherein the ratchet mechanism includes a ratchet wheel, and a gear train converts the displacement of the chain guiding member to a rotation of the ratchet wheel.

11. An automatically tensioning mechanism as claimed in claim 10, wherein the ratchet mechanism includes a pivotal pawl, a pivotal slide that is pivotally carried by the arm connecting the hinged cover to the push/pull rod member, and the pivotal slide controlling activation/deactivation of the pivotal pawl.

12. An automatically tensioning mechanism as claimed in claim 8 wherein the mechanism further includes a second shaft, on which the chain guiding member and the second gear are coaxially mounted thereby operatively connecting them on the second shaft, and a support device that is pivotal on a rotation axis of the output shaft and carries the second shaft for pivotal movement of the chain guiding member substantially in a longitudinal direction of the guide bar.

13. An automatically tensioning mechanism as claimed in claim 12, wherein the gear transmission further includes an intermediate third gear mounted on a third shaft carried by the support device and meshing with the first gear and the second gear to transmit rotation of the first gear to the second gear and thus to drive the chain guiding member.

14. An automatically tensioning mechanism as claimed in claim 13, wherein the support device includes a first link maintaining a predetermined distance between the output shaft and the third shaft, a second link maintaining a predetermined distance between the third shaft and the second shaft, and a pivotal third link having a fixed end and an opposite end that carries the second shaft, said first link and second link forming a variable angle elbow to permit the chain guiding member to move toward or away from the output shaft.

15. An automatically tensioning mechanism as claimed in claim 14, wherein the output shaft with the first gear is arranged between the guide bar and the chain guiding member and substantially on a level with them.

16. An automatically tensioning mechanism as claimed in claim 12, wherein the support device includes a pivotal housing enclosing the gears, and the first and second gears are in direct meshing engagement with each other.

17. An automatically tensioning mechanism as claimed in claim 7, wherein the chain guiding member is a drive sprocket driving the chain.

18. An automatically tensioning mechanism as claimed in claim 8, wherein the chain guiding member is a ring member loosely surrounding the first gear, the ring member having a radially outer side shaped to guide the saw chain and a radially inner side structured for a meshing engagement with the first gear.

19. An automatically tensioning mechanism as claimed in 18, wherein the pre-tensioning mechanism is a spring-operated mechanism that presses the ring member against the first gear in a direction away from the guide bar thereby providing a pre-tension of the chain.

20. An automatically tensioning mechanism as claimed in claim 18, wherein the first gear has support surfaces for supporting varying supported surfaces on the radially inner side of the ring member, the ring member has radial through openings for inwardly extending portions of drive links included in the saw chain, and the first gear being a driving sprocket that has teeth with portions engaging the drive links.

21. An automatically tensioning mechanism as claimed in claim 20, wherein each tooth of the first gear has two lateral ends with recessed portions that form shoulders, which constitute said support surfaces, the remaining intermediary top portion of each tooth being the portion that engages the drive links.

22. An automatically tensioning mechanism as claimed in claim 21, wherein the ring member comprises two axial halves interconnected by rung-like members like in a ladder, the space formed between the two halves constituting the radial through openings for the inwardly extending portions of drive links.

23. An automatically tensioning mechanism as claimed in claim 20, wherein the pre-tension mechanism includes a holder adapted to be attached to a rear end of the guide bar, two parallel rods mounted movably on the holder and extending side by side in the direction of the guide bar, each rod having a portion extending rearward from the holder and in addition an end located proximate the ring member, the rod ends being interconnected by a cross piece, the cross piece having a projecting member adapted to contact the radially outer side of the ring member, and helical compression springs being mounted around said portions of the rods to press the projecting member against the radially outer side of the ring member and thereby ensuring a minimum tension in the saw chain and driving engagement between the first gear and the saw chain.

24. An automatically tensioning mechanism as claimed in claim 23, wherein the projecting member includes a rotary wheel adapted to contact the radially outer side of the ring member.

25. An automatically tensioning mechanism as claimed in claim 23, wherein the rods have distal ends provided with a threaded portion and a nut screwed onto the threaded portion for pre-tensioning the compression springs.

26. An automatically tensioning mechanism as claimed in claim 19, wherein the pre-tensioning mechanism presses the ring member against the first gear at a position below the center of the first gear.

27. An automatically tensioning mechanism as claimed in claim 18, wherein the first gear, and the outer ring member have meshing teeth arranged to form a smaller pitch circle and a larger pitch circle, and a device is provided for allowing a center of the outer sprocket ring member to move along a restricted angular path formed by a periphery of a semicircle around a center of the driving inner sprocket, said semicircle having a diameter that is equal to a difference in diameter between the two pitch circles.

28. An automatically tensioning mechanism as claimed in claim 27, wherein the device comprises:
a) a chainsaw platform that is integral with or adapted to be fixed to a chainsaw housing;
b) a slide plate that is carried by and movable in relation to the chainsaw platform;
c) a rolling-element bearing having an outer race ring and an inner race ring and having one of the race rings fixed to the slide plate, said outer sprocket ring member being fixed to the other race ring;
d) a rotary shaft carried by the chainsaw platform and extending through a semicircular opening in the slide plate, said shaft being operatively connected to the slide plate to move it upon rotation of the shaft;
e) a plurality of eccentric bearings connecting the slide plate to the chainsaw platform to restrict the movement of the slide plate to movements along said semicircular path; and
f) a spring member having one end attached to the chainsaw platform and the other end to the shaft in such a manner that the slide plate with the outer ring member maintains the saw chain pre-tensioned.

29. An automatically tensioning mechanism as claimed in claim 27, wherein the ring member has external teeth for engaging the inwardly extending portions of drive links of the saw chain.

30. An automatically tensioning mechanism as claimed in claim 7, further including a quick-action device for facilitating attachment/detachment of a saw chain.

31. An automatically tensioning mechanism as claimed in claim 7, wherein the automatic tensioning mechanism is employed on a chain saw having a quick-action device.

32. A method for automatically tensioning a chain of a chainsaw, wherein the method comprising providing a mechanism including a saw chain, a guide bar and a rotatable chain guiding member for guiding the chain, a driven output shaft, and a gear transmission for operatively connecting the output shaft to the chain guiding member, the method characterized by further including:
a) running the chain, whereby forces result in the gear transmission due to resistance from rotating the rotatable chain guiding member, and
b) utilizing said resulting forces to displace the rotatable chain guiding member away from the guide bar so as to tension the chain.

33. A method as claimed in claim 32, characterized by providing a chain tension maintaining mechanism that maintains the chain tension upon reduction of the chain speed by preventing the rotatable chain guiding member from moving toward the guide bar.

34. A method as claimed in claim 33, wherein the chain tension maintaining mechanism is a ratchet mechanism.

35. A method as claimed in claim 32, characterized by providing a pre-tensioning mechanism operatively connected to the chain guiding member biasing the chain guiding member in a direction away from the guide bar to ensure that at least a minimum tension of the chain is provided at start of the chain saw.

36. A method as claimed in claim 32, wherein the gear transmission includes a first gear fixed on the output shaft, and a second gear mounted coaxially with the chain guiding member and operatively connected thereto.

37. A method as claimed in claim 36, wherein the mechanism further includes a second shaft, on which the chain guiding member and the second gear are coaxially mounted thereby operatively connecting them on the second shaft, and a support device that is pivotal on a rotation axis of the output shaft and carries the second shaft for pivotal movement of the chain guiding member substantially in a longitudinal direction of the guide bar.

38. A method as claimed in claim 36, wherein the gear transmission further includes an intermediate third gear mounted on a third shaft carried by the support device and meshing with the first gear and the second gear to transmit rotation of the first gear to the second gear and thus to drive the chain guiding member.

39. A method as claimed in claim 38, wherein the support device includes a first link maintaining a predetermined distance between the output shaft and the third shaft, a second link maintaining a predetermined distance between the third shaft and the second shaft, and a pivotal third link having a fixed end and an opposite end that carries the second shaft, said first link and second link forming a variable angle elbow to permit the chain guiding member to move toward or away from the output shaft.

40. A method as claimed in claim 39, characterized by arranging the output shaft with the first gear between the guide bar and the chain guiding member and substantially on a level with them.

41. A method as claimed in claim 37, wherein the support device includes a pivotal housing enclosing the gears, and the first and second gears are in direct meshing engagement with each other.
